(19) United States
(12) Patent Application Publication
(10) Pub. No.: US 2018/0043487 A1
(43) Pub. Date: Feb. 15, 2018

(54) MACHINE TOOL AND METHOD FOR THE EFFICIENT AND FLEXIBLE PRO-DUCTION OF MACHINING PATTERNS BY MEANS OF A NUMBER OF SPINDLES

(71) Applicant: Demmeler Automatisierung und Roboter GmbH, Heimertingen (DE)

(72) Inventor: Johannes DEMMELER, Heimertingen (DE)

(21) Appl. No.: 15/545,239

(22) PCT Filed: Jan. 29, 2016
(86) PCT No.: PCT/EP2016/051992

§ 371 Date: Jul. 20, 2017

(30) Foreign Application Priority Data
Jan. 30, 2015 (DE) 10 2015 001 061.1

(51) Int. Cl. B23Q 3/157; B23Q 39/02; B23Q 1/70; B23B 39/16

(52) U.S. Cl. CPC B23Q 3/157; B23B 39/161; B23Q 39/023; B23Q 1/70; B23Q 2039/002

(57) ABSTRACT

The device and the corresponding method according to the invention relate in particular to a CNC machine tool and a machining method preferably for large machining patterns. The CNC machine tool may comprise a machining head 2 which may be connected to a Z-axis 1 such that it can be manually and/or automatically changed, and which may have at least two tool spindles 3 for receiving tools 4. The Z-axis 1 can be moved in a linear manner at least along two linear axial directions. The Z-axis 1 and/or the machining head 2 may have at least one axis of rotation.

The machine tool described herein and the associated method make it possible, for example, to produce bores along/on a radius or a circle (bore pattern or hole circle) in a highly efficient manner and faster than previously possible. The hole circle, on which the bores may be arranged, may have a diameter of several meters, as is necessary, for example, in the production of rotor hubs of wind turbines.

In the prior art, machine tools with multi-spindle machining heads are known, which can process linearly arranged machining patterns.

There is a need for a machine tool and a method for faster and more efficient processing of machining patterns which are linearly and/or otherwise arranged. In particular, there is a need for the possibility of faster and more efficient processing of circularly arranged machining patterns, e.g. of bores arranged along a bore pattern, in particular a radius or circle with large dimensions of up to several meters.

The object is achieved by the invention according to the independent patent claims. Preferred further developments are described in the dependent patent claims.

One aspect of the invention relates to a (computer-assisted) numerically controlled machine tool or a CNC machine tool. The machine tool may comprise a machining head, preferably a drilling head, which may be connected to the machine tool, in particular to a Z-axis (Z-shaft) of the machine tool. The connection between the machining head and the machine tool may preferably be manually and/or automatically changeable. Furthermore, the machining head may have at least two tool spindles for receiving tools.

Here, it should be noted that the Z-axis may be rotatable or may have an axis of rotation or a rotational degree of freedom, i.e., may have a C-axis integrated. Furthermore, the machine tool and preferably the Z-axis may have two linear(ly) (displaceable) axes along a (e.g., horizontal) plane, which herein may also be referred to as the X and Y axes/directions. The (at least) two linear axes/directions are preferably perpendicular to each other.

Furthermore, the Z-axis may also be displaceable along a third linear axis, which may be perpendicular to the plane which is spanned by the X and Y directions and which herein may also referred to as a vertical axis (in the Z direction, perpendicular to the X-Y plane).

In other words, the Z-axis may at least be (linearly) displaceable along two linear axial directions, and the Z-axis and/or the machining head may have at least one axis of rotation (may be rotatable), which may be implemented by means of an integrated C-axis. An axis of rotation of the machining head may, for example, be provided in such a way that the machining head may be rotatably supported relative to the Z-axis. Further, a direct motor drive may also be provided in the machining head to allow driving/rotating the machining head directly. Integration of the C-axis into the Z-axis makes it possible to rotate machining heads into which a C-axis is difficult to integrate.

Furthermore, the machine tool may be configured to process or produce machining patterns in that the machining head can be moved to a position of the machining pattern/drilling pattern by linearly displacing the Z-axis. The displacement preferably takes place along at least one of the linear axial directions. The tools of the machining head may be aligned with a contour of the machining pattern/drilling pattern. For this purpose, the machining head and/or the Z-axis may be rotated (by means of the C-axis).

Preferably, drilling patterns may be produced or machined with the machine tool. Strongly preferably, the bore patterns are radii/circle sections or, even more preferably, (whole) hole circles. The drilling patterns may include a plurality of bores on a contour of the drilling pattern. For example, the contour of the drilling pattern in the case of a circular section or a hole circle may be a diameter or outer diameter of the hole circle, wherein the holes may be arranged at a distance from one another along/on the diameter.

In other words, the machine tool may be configured to create/produce bores along a hole circle due to the machining head being movable to a position on the hole circle by linearly displacing the Z-axis along the linear axial directions. The tools of the machining head may be alignable with the hole circle by means of a rotation of the machining head and/or the Z-axis.

The position of the drilling pattern, for example on the hole circle, may be determined, for example, by means of the (X, Y) coordinates of the machining head position. In the case of a hole circle, for example, it may be a machining goal to make holes at the positions of the/on the hole circle, e.g., at 0°, 90°, 180°, and 270° of the hole circle. For this purpose, the drilling head may be moved (linearly) to the aforementioned positions. The drilling may be performed, for example, by (linearly) displacing the drilling head and/or the Z-axis in the Z-direction.

It should be understood, that aligning the tools means, in particular, that, preferably after the machining head has been moved into position, the tools are positioned in accordance with the drilling pattern, its contour or the diameter (in the case of a hole circle), i.e., are aligned, so that the bores are actually located on the contour, e.g., the diameter.

In other words, the machine tool may be positioned quickly and precisely by means of at least two Cartesian machine axes and a rotary axis. The rotary axis may be a component of the machine (tool) and/or (preferred or) of the (machining) head.

Therefore, technical advantages are that, in particular, circularly arranged (but also linear) drilling patterns, preferably hole circles, may be produced and processed economically, efficiently and quickly with multi-spindle drilling heads, whereas up to now only linearly arranged machining patterns could be processed.

Furthermore, the relative position of the tool spindles with respect to each other may be changed manually and/or automatically. In particular, the distance between the tool spindles relative to one another may be variable so that, for example, different drilling distances are possible within a drilling pattern without a head change, which allows for very fast and efficient machining.

Furthermore, the machine tool may have at least two tool spindles arranged on at least one eccentric. Particularly preferably, one eccentric is assigned to each tool spindle. However, other arrangements are possible. The eccentrics may preferably be positioned via a motor.

The eccentrics may be connected to the machining head and a relative position between the tool spindles, in particular a distance between the tool spindles, may be adjustable by rotating the eccentrics.

Particularly advantageously, the use of eccentrics or the configuration with eccentrics allows for less complex driving/rotating (e.g., the tools) by means of a main working spindle of the machine via gears or makes connecting to the main working spindle of the machine by means of gears possible.

However, the relative position may alternatively or additionally be adjustable such that the tool spindles or the tools are not arranged on a horizontal line but, for example, on a curved line or a straight inclined line.

The adjustment of the relative positions of the tools with respect to each other makes it possible to generate, for example, variable distances between the bores of a drilling pattern. Further, by rotating the rotation axis, the spindle distance may be adjusted in order to mill, e.g., several grooves linearly.

Furthermore, the machine tool may include the at least two tool spindles, which may be arranged in a non-adjustable (fixed) distance from one another on the machining head. This makes the machining head less complex and less expensive; it is also possible to process circularly arranged machining patterns quickly and efficiently with the aid of the machine axes described above, the spacing and the pitch of the drilling patterns being firmly defined.

Furthermore, a machine tool may have at least three tool spindles arranged at a non-adjustable distance from one another on the machining head, the tool spindles being arranged on a straight line or on a curved line. The curved line may be/have, for example, a radius which may correspond to a predetermined hole pattern. The arrangement of many tools on the machining head allows an even faster processing. Predetermining a radius on which the tools are arranged reduces the time for setting the distances and aligning the tools with predefined drilling patterns.

Furthermore, the machine tool may be configured such that at least two tool spindles can be arranged on at least two linear guides, which may be connected to the machining head. A distance between the tool spindles may be adjustable by linearly displacing the tool spindles by means of the linear guides.

The adjustment of the machining spindles or their relative position, either rotationally (e.g., by means of eccentrics) or linearly in combination with the above-described machine axes, makes it possible to process any desired linearly and circularly arranged drilling patterns using multiple spindles in a quick and cost-efficient manner. In particular, hole distances may be varied for each or selected processing step(s).

The relative position or the distance between the tool spindles may be adjusted both manually and numerically (autonomously and/or automatically). In particular the latter possibility offers the advantage that a further reduction of the machining times may be realized.

Furthermore, the machining head and/or the tool(s) may be changeable manually and/or automatically/autonomously. Preferably, a pick-up method is used for the automatic change. It is characterized in that the Z-axis or the machining head (with/without Z-axis) may be displaced automatically to a deposit station for machining heads or to a pick-up magazine for tools. There, the machining head may be loosened and deposited automatically. There, the tool may be loosened and deposited automatically. Thereafter, another machining head or another tool may be inserted automatically. The machining of drilling patterns may thus be performed in a fully automatic manner.

Furthermore, the machining head may have at least a second axis of rotation. The second axis of rotation allows for rotating or swiveling in addition to the first rotation axis so that further machining sides on a workpiece may also be machined. For example, the second axis of rotation allows changing from a vertical machining to machining which is offset/swiveled by 90°.

Furthermore, the machine tool may include an automatic tool changer (double gripper head) which has at least two receptacles/grippers for tools so that an automated change of tools, e.g., in combination with a chain magazine or the like, becomes possible.

The tool spindles may have an internal lubricant feed so that an optimal supply of lubricant is made possible without external lubricant feeds interfering with the machining.

Furthermore, a method for the (multi-spindled) production of linear and/or circularly arranged machining patterns with a machine tool is described herein. Preferably, a machine tool as described above is used/employed for the method.

The method may comprise the steps of (in any order, but preferably in the following order): moving to a position on/of the machining pattern with the machining head by means of a linear displacement of the Z-axis along one, two (or more) linear axial directions. (Here, what is meant is that is a displacement, for example in the X and Y axial directions, need not always be necessary for every displacement, but it is possible. It may also be possible to move to a position in such a way that only one displacement in the X or Y axial direction is sufficient). Arranging the tools of the machining head on a contour line of the machining pattern, for example the outer diameter of the hole circle, by rotating the machining head and/or the Z-axis. In other words, the tools and the machining pattern are aligned with each other. In the case of a drilling pattern, drilling of the bores may also be carried out.

Technical advantages are that, in particular, circularly arranged (but also linear) drilling patterns, preferably hole circles, can be produced or processed with multi-spindle drilling heads, while previously only linear machining patterns could be processed.

Furthermore, the method may comprise the step of: adjusting the relative position, in particular the distance between the tool spindles, before processing the machining pattern, in particular the hole pattern. Furthermore, such an adjustment may be carried out additionally or alternatively before each drilling operation or before predetermined drilling operations. This makes it possible to perform an adjustment of the arrangement of the tools to the drilling pattern very flexibly and automatically (but also manually).

Furthermore, the method may comprise the step of: drilling by displacing the Z-axis and/or the machining head in a linear axial direction (perpendicular axis) which is perpendicular to a plane which is spanned by the further linear axial directions.

Furthermore, the method can comprise the step of: automatically changing the machining head and/or the tool by means of the pick-up method, which has already been described above. Automatic changing, e.g. by means of pick-up methods (other methods are also possible), permits further automation and thus acceleration of the processing of a machining pattern.

Furthermore, the method can comprise an automatic changing of the tool by means of an automatic tool changer. The automatic tool changer is preferably a tool changer as is already used for single-spindle machining heads. The steps for changing may preferably be carried out in the following order. However, the order can also be changed. The steps may comprise: arranging or removing a first tool on/from the associated tool spindle by means of the automatic tool changer. (Linearly) displacing the Z-axis, preferably along the Y-direction, to a position in which the tool changer can insert or remove a second tool. The position which is approached is thus preferably the position at which a (middle) axis of the receptacle of the tool changer is coinciding with the longitudinal axis of the tool or of the tool spindle. The position may also be described as follows: the receptacle is arranged above (in the case of a top view on the tool changer) of the tool spindle such that both are substantially directly above one another. Furthermore, the step of: arranging or removing the second tool on/from the associated tool spindle by means of the automatic tool changer.

Additional steps are possible. That is, before, between and/or after the aforementioned steps, the tool changer may be moved to a magazine, e.g., a chain magazine, in order to pick up new tools or to deposit replaced tools, for example.

Technical advantages of the above-described changing include that known tool changers of single-spindle machining heads may be used, wherein displacing the Z-axis substantially allows for a quick and less complex replacement or equipment of the tools of the multi-spindle machining head. Since the tool changers regularly have two receptacles (grippers), intermediate steps with regard to depositing and/or newly receiving tools in the magazine may be used, in particular in the case of machining heads with more than two tool spindles. In summary, equipping and exchanging tools may thus be carried out quickly and flexibly using existing tool changers even with multi-spindle machining heads.

Alternatively or in addition to the aforementioned steps for automatically changing the tool by means of an automatic tool changer, the following steps may also apply (in the preferred order as indicated below or in a different order): arranging or removing a first tool on/from the tool spindle by means of the automatic tool changer. Rotating the Z-axis and/or the machining head to a position in which the tool changer can insert or remove a second tool. Thus, the rotation is preferably 180°, so that the position of the tool spindle coincides with again the position of the receptacle of the tool changer. Arranging or removing the second tool on/from the associated tool spindle by means of the automatic tool changer.

Additional steps are possible. That is, before, between and/or after the aforementioned steps, the tool changer may be moved to a magazine, e.g., a chain magazine, in order, for example, to pick up new tools or to deposit replaced tools.

Technical advantages of the above-described changing as well include that known tool changers of single-spindle machining heads can be used. Since the tool changers regularly have two receptacles, intermediate steps with regard to depositing and/or newly receiving tools in the magazine may be used, in particular in the case of machining heads with more than two tool spindles. In summary, the equipment and change of tools may thus be carried out quickly and flexibly with existing tool changers even in the case of multi-spindle machining heads.

In summary, a multi-spindle machining, in particular of large hole circles, is made possible in minimized machining time, and also a quick and efficient changing of the tools can be realized.

The device set forth herein and everything related are described below by way of example with reference to the accompanying schematic drawings. In the figures:

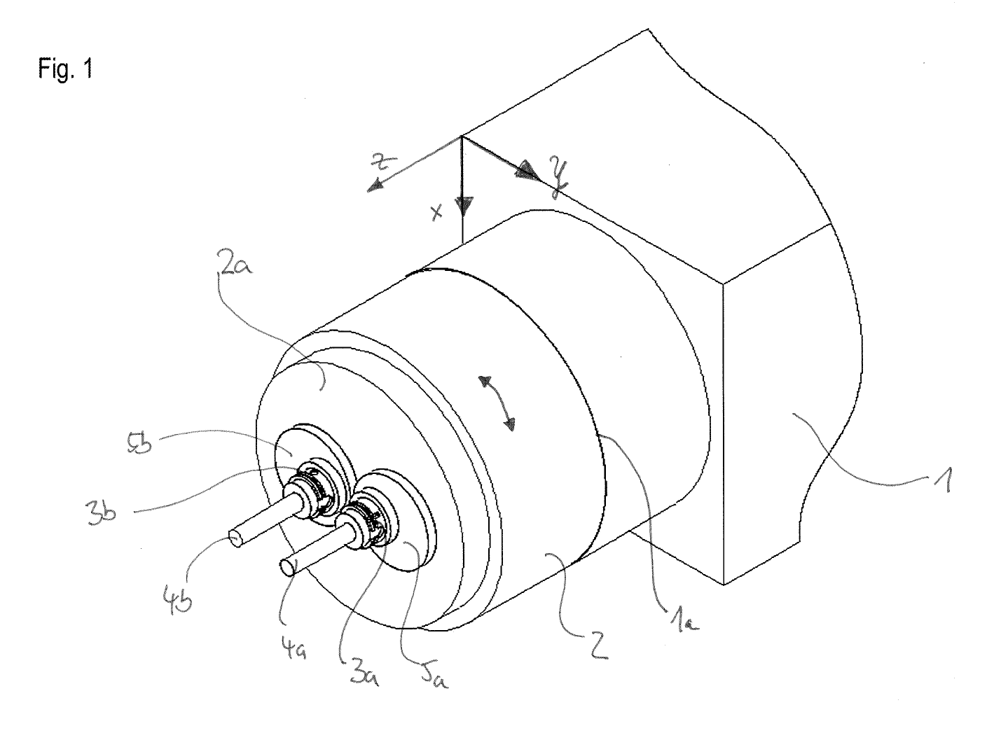

FIG. 1 shows a portion of a CNC machine tool,

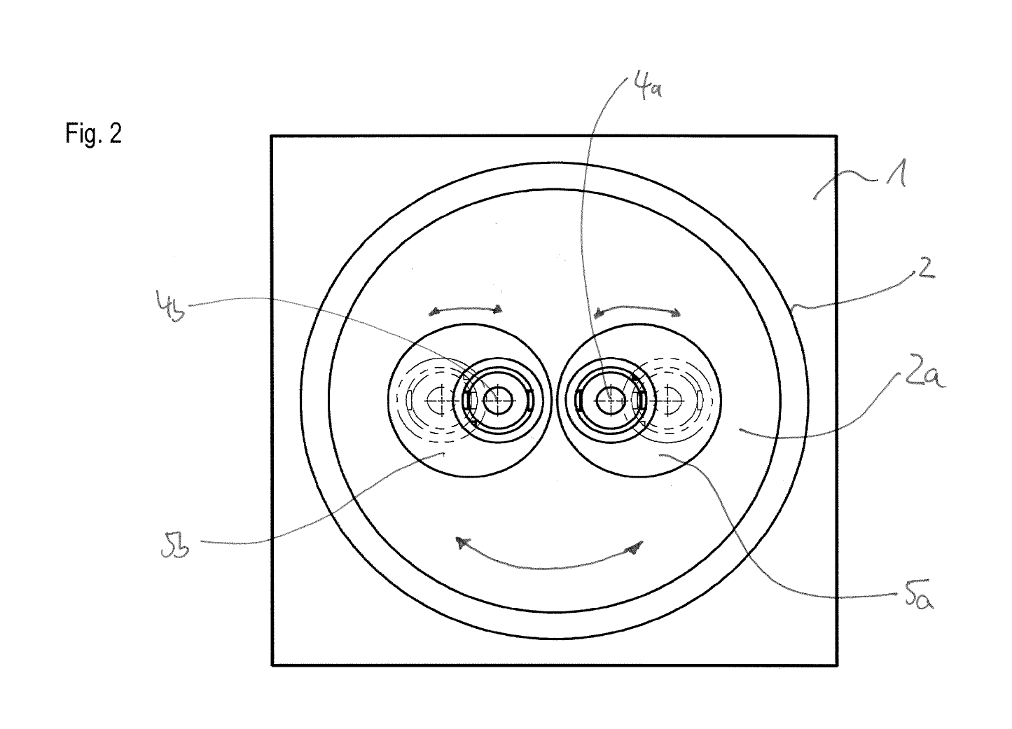

FIG. 2 is a front view of the machining head of the CNC machine tool,

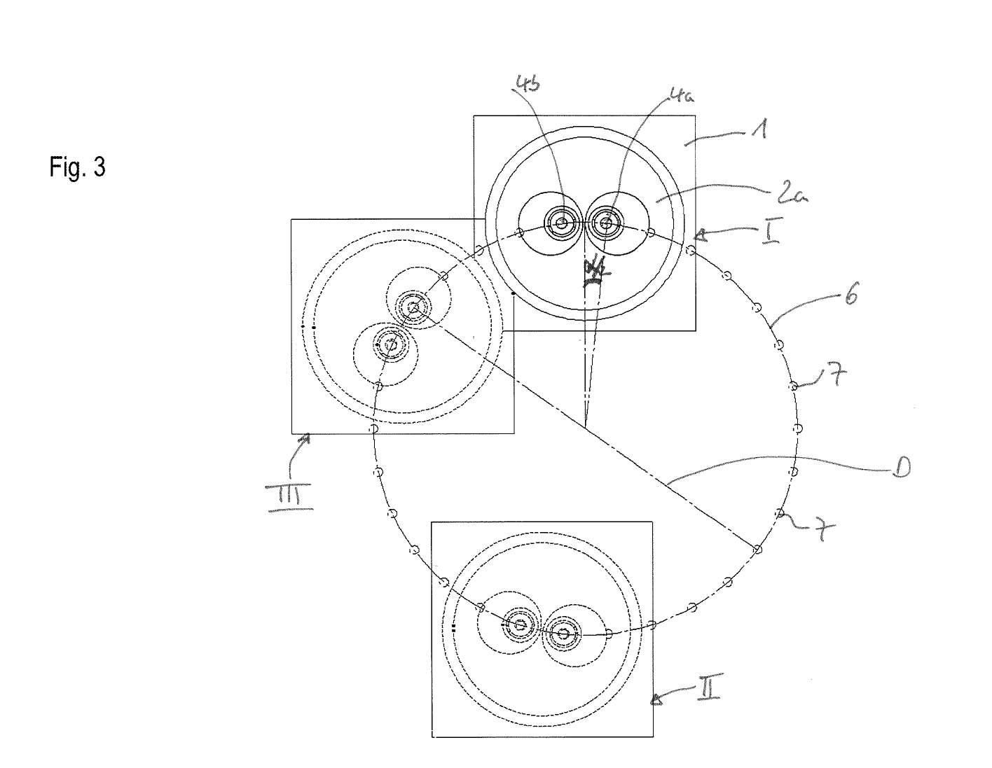

FIG. 3 shows an example of a machining pattern,

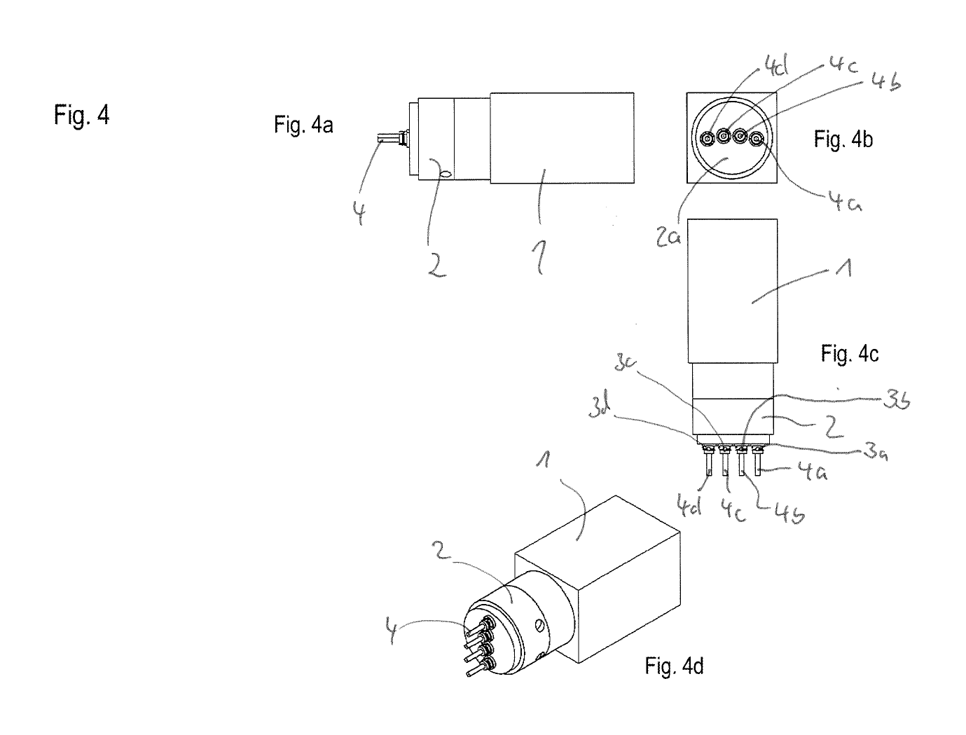

FIGS. 4a-d are views of a portion of a CNC machine tool,

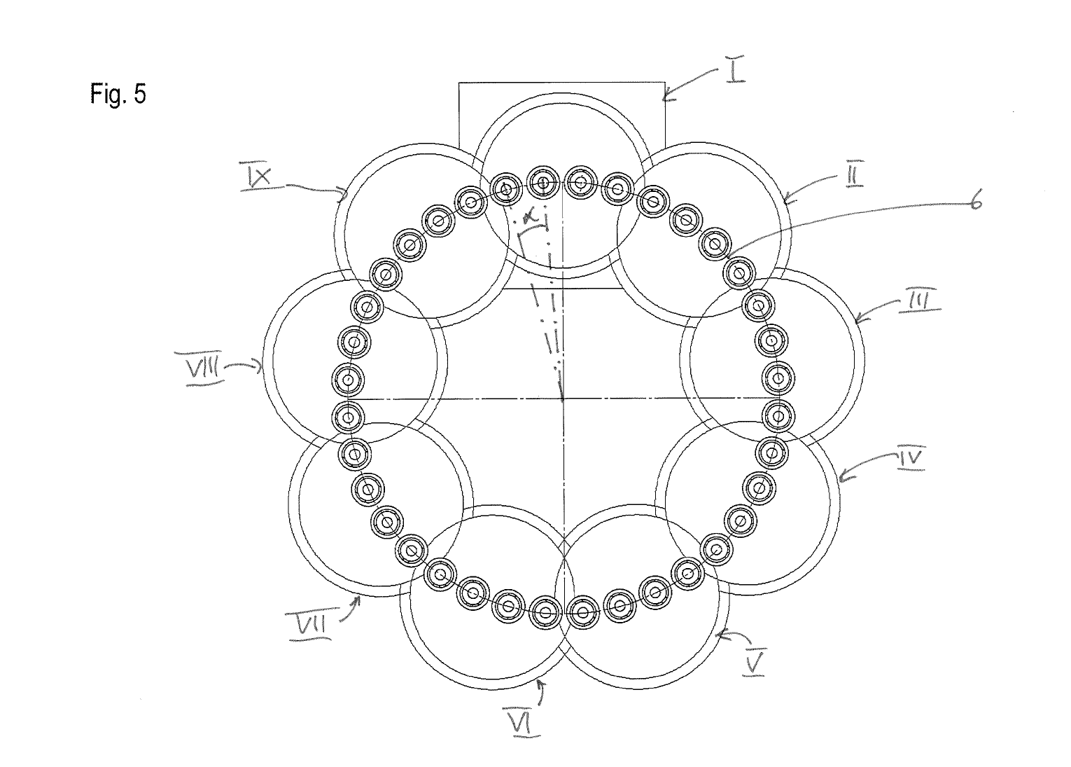

FIG. 5 shows another example of a machining pattern,

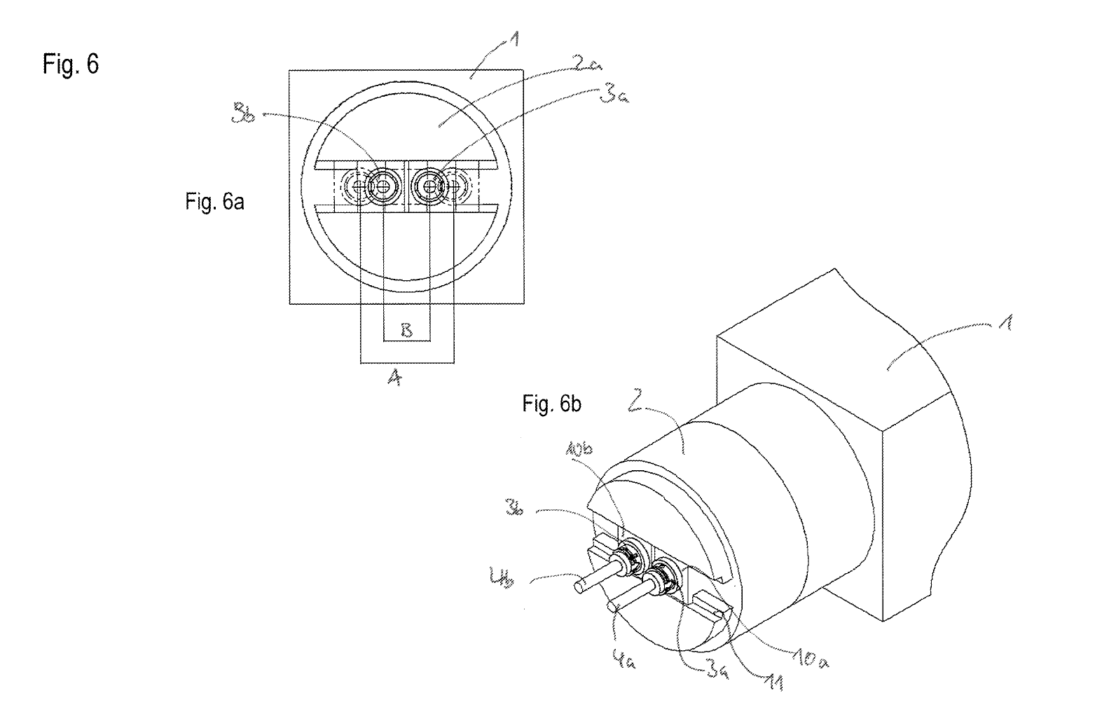

FIGS. 6a-b are views of a portion of a CNC machine tool,

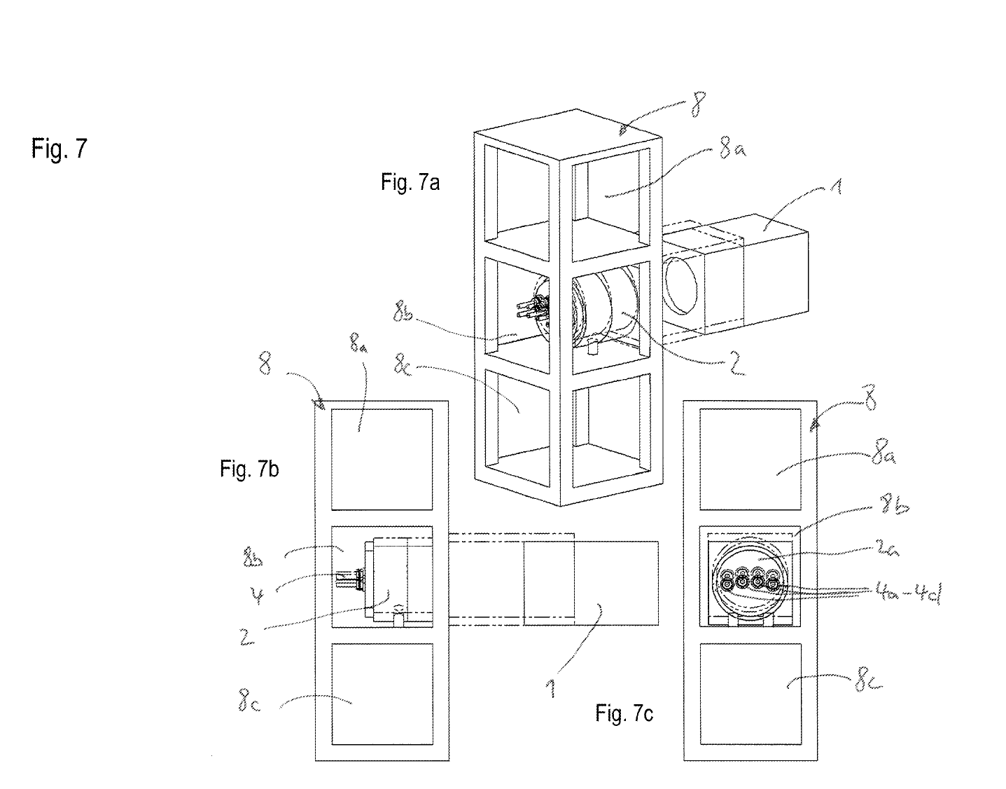

FIGS. 7a-c are views of a deposit station for machining heads,

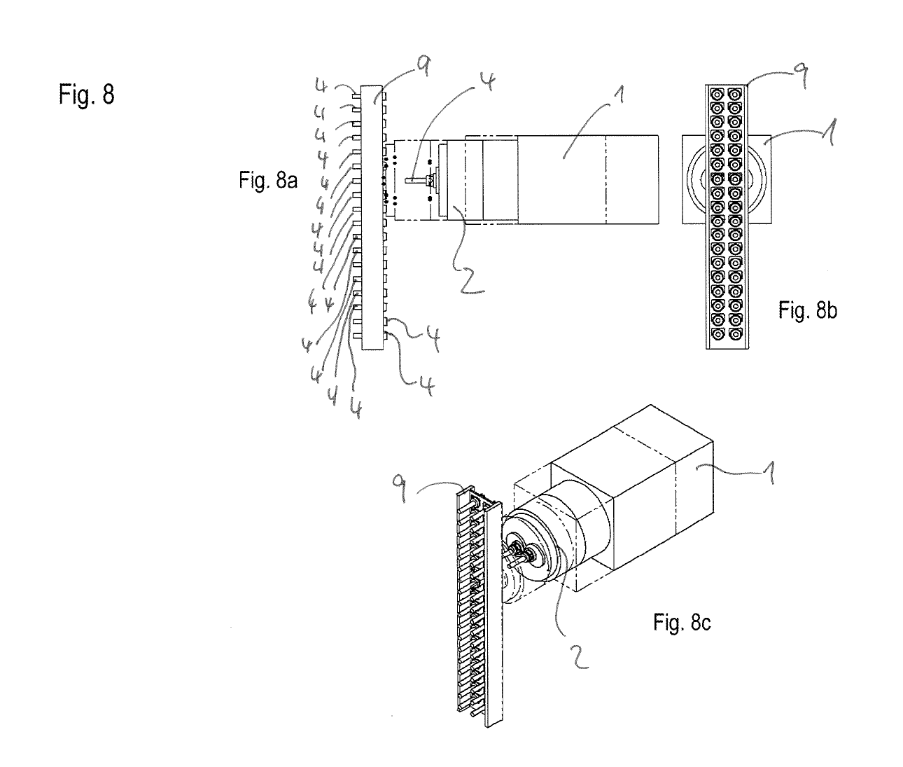

FIGS. 8a-c are views of a magazine for tools,

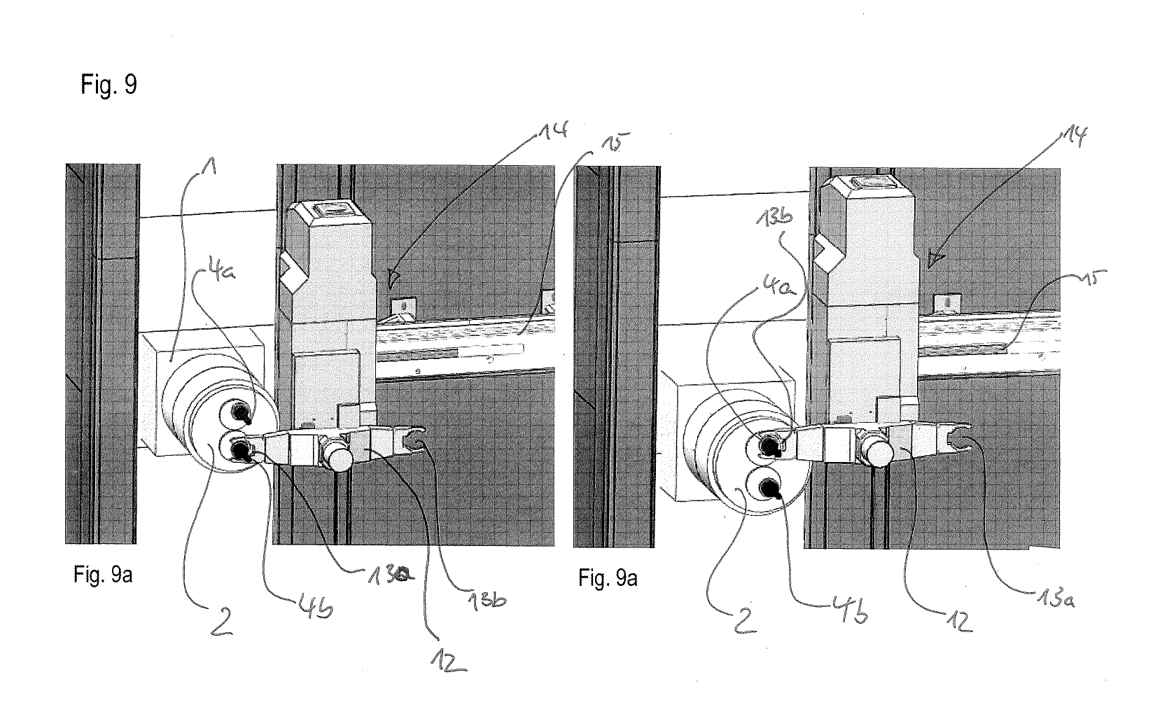

FIGS. 9a-b are views showing a changing operation, and

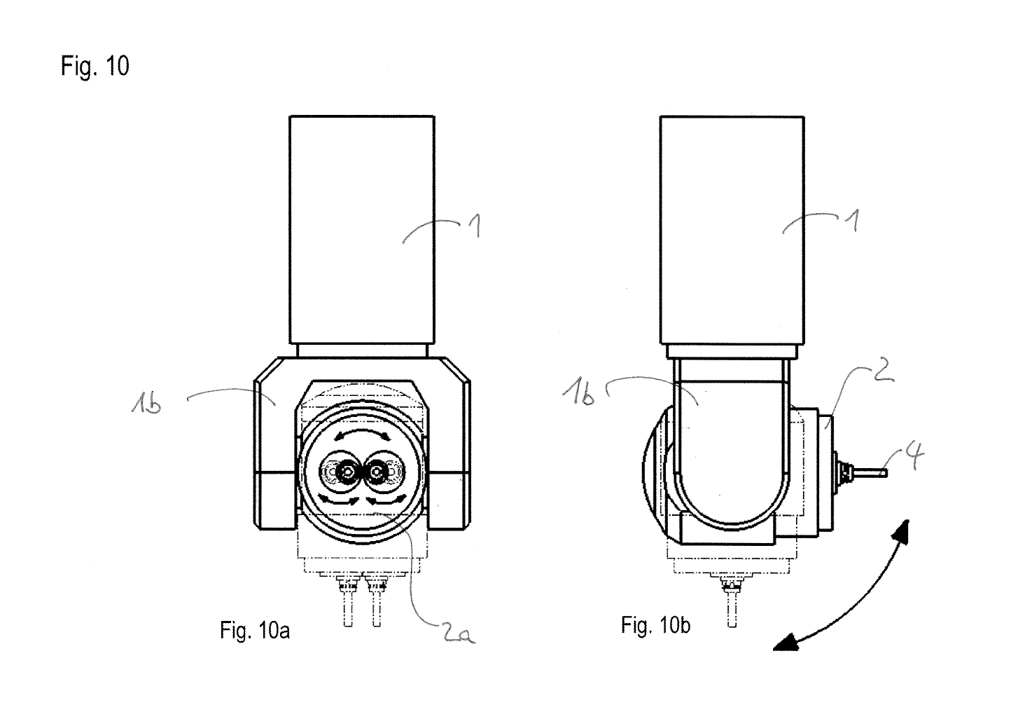

FIGS. 10a-b are views of a portion of a CNC machine tool.

In the following, various examples will be described in detail and with reference to the figures. The same or similar elements in the figures are designated by the same reference symbols. However, the present device and method are not limited to the described combinations of features. Rather, further modifications and combinations of features of various examples are intended to be included within the scope of the independent claims.

FIG. 1 shows a part of the machine tool described herein. In particular, the figure shows (in a truncated manner) a part of a Z-axis 1 which is linearly displaceable at least along the indicated linear axial directions X and Y. Furthermore, an axial displaceability in the Z-direction is also preferred.

The Z-axis 1 includes an interface 1a, on which a machining head 2 is arranged changeably/detachably. The machining head 2 has at least one rotational degree of freedom, which is indicated by means of the double arrow. This degree of freedom may be provided by means of an axis of rotation of the machining head 2 and/or the Z-axis 1. FIG. 2 shows, by way of example, a continuous pivotability or rotatability of the machining head 2 relative to the Z-axis 1, which is indicated by the largest of the three double arrows.

FIG. 2 further shows that two tool spindles 3 are arranged on a front side 2a of the machining head 2, each of which holds a tool 4, here drilling tools 4a, 4b, rotatably and changeably. The two smaller double arrows indicate a rotatability of the two tool spindles 3, which makes it possible to vary their relative position, as, by way of example, is indicated by the dashed parts of the drawing.

FIG. 1 also shows that the two tools 4a, 4b or their tool spindles 3 are each arranged on an eccentric 5a, 5b. As already mentioned, FIG. 2 shows a front view of the machining head 2, which indicates, by means of double arrows, the continuous 360° rotatability/pivotability of the machining head 2 and the Z-axis 1 as well as the adjustability of the relative position of the tools 4a, 4b by rotating the eccentrics 5a, 5b.

FIG. 3 shows an example of machining a hole circle 6 as a machining pattern. The Roman numerals I-III indicate positions to which the Z-axis 1 is moved (indicated by dashed contours) with the machining head 2 at different times in order to drill/bore bores 7 at this position on/along the hole circle 6. The radius or diameter D of the hole circle 6 is arbitrary, but preferably relatively large, e.g., the diameter may be half a meter, one meter, more than one meter or several meters. The hole pattern or the curved machining pattern may also be arbitrary. The angular pitch α or α/2 and/or distances between the bores 7 may be selected in a continuous manner. The positions I-III are reached precisely by the machine tool or the Z-axis 1 by correspondingly displacing the Z-axis 1 along the X and/or Y direction until the desired position is reached.

Preferably after reaching the position, e.g., I, II or III (more or less positions are possible), the machining head 2 is rotated/pivoted. For this purpose, either the Z-axis 1 (if it has a C-axis or is configured as one) is continuously rotated and/or the machining head 2 itself is rotated relative to the Z-axis 1. Alternatively, it is also possible for the rotation to be carried out before moving to the (machining) position I-III. The rotation is performed in this way and serves to orient the tools 4a, 4b in such a way that the bores 7 to be bored are actually arranged on the hole circle 6, as shown in FIG. 3 with the empty points on the outer diameter of the hole circle 6.

An alternative to the example described above is given in FIGS. 4a-d. By way of example, a machining head 2, which includes four tool spindles 3a-d and tools 4a-d, is shown. In this example, the tool spindles 3 are connected to the machining head 2 with fixed (unchangeable) spacing and arrangement with respect to one another. In addition, the tools 4 are arranged on a curved line with respect to one another, as is particularly apparent from the partial FIG. 4b, so that drilling at a fixed angle α, which is predetermined by the shape of the curved line, is made possible, as is illustrated by FIG. 5 via a further machining pattern/hole circle 6. The further features of this example of FIGS. 4a-d may correspond to the example(s) already described with reference to FIGS. 1-3.

FIG. 5 shows, as explained above, a further hole circle 6 which comprises the machining positions I-IX, wherein at each position four bores 7 are bored by means of the above-described machining head 2 in a single drilling step. Again, each position I-IX is reached by translatory displacement of the Z-axis 1. Furthermore, a rotation is performed which aligns the tools 4 with the hole circle 6.

FIGS. 6a-b show a further example which differs from the above-described examples in that the tool spindles 3 are each arranged on a translatory displacing device 10 (linear guide), and can be displaced/moved linearly (automatically or manually), e.g., along a rail 11 of the machining head 2 in such a way that the distance between the two tool spindles 3a, 3b shown may be set precisely and accurately.

Furthermore, FIGS. 7a-c schematically show a (pick-up) deposit station 8 which has a plurality of compartments 8a-c into which at least one machining head 2 can be inserted, respectively. If a machining head 2 is to be (automatically) changed, the Z-axis 1 is moved to a compartment 8a-c, where the machining head 2 is detached from the Z-axis 1 and deposited as is known. Thereafter, the Z-axis 1 is moved to another compartment 8a-c, in which another desired machining head 2 is deposited. This machining head 2 is then mounted automatically/autonomously on the Z-axis 1. The Z-axis 1 can then be moved back to the workpiece.

Furthermore, FIGS. 8a-c schematically show a (pick-up) tool magazine 9. The tool magazine 9 holds, in different positions, a plurality of different tools 4 which may be connected automatically/autonomously to a tool spindle 3 of a machining head 2. For this purpose, the Z-axis 1 is moved to the tool magazine 9, gripped tools 4 are released and deposited, and other tools 4 are gripped as known. The change of machining heads 2 and/or tools 4 may also be carried out manually. In addition, the (pick-up) tool magazine 9 may alternatively or additionally hold tool spindles 3 in stock.

FIG. 9a shows the change/insertion of a tool 4b by means of an automatic tool changer device 14 which includes an (automatic) tool changer 12 which can be displaced in a translational and rotational manner. The tool changer (double gripper head) 12 includes a receptacle/gripper 13a, 13b at its longitudinal ends, respectively, with which tools 4 can be gripped in order to take them from a magazine, insert them into a magazine, remove them from the tool spindle 3, insert them into the tool spindle 3, etc. The method shown in FIGS. 9a and 9b shows an example insertion/change of the tools 4a and 4b of the two-spindle machining head 2. The first tool, e.g., having reference sing 4b, may therefore first be gripped by the gripper 13a and, e.g., be Inserted or removed (into/from the tool spindle 3b). Thereafter, the Z-axis 1 can be displaced linearly downwards in the figures until the gripper 13 (e.g., the gripper 13a after a 180° rotation of the tool changer 12) is aligned with the tool spindle 4a so that the tool 4a can be removed or inserted there. Furthermore, it may be possible for the tool changer 12 to be moved along the rail 15 to the magazine or the like before, after or between the insertion or removing steps shown. In addition, the tool changer 12 may also be used for initially removing a tool 3 from the tool spindle 4, and then be rotated by 180° in order to insert an already prepared tool 3 with the second gripper 13a, b. The tool changer 12 may then be moved to the magazine while the Z-axis 1 may be displaced linearly to the position in which the second tool 3 can be changed when the tool changer has returned from the magazine (this position is shown, for example, in FIG. 9b).

Not shown is a further possibility of positioning the tool spindle 4 to the gripper 13, wherein a rotation of the Z-axis 1 or of the machining head 2 is performed, preferably by 180°, instead of (or in addition to) a linear displacement thereof, so that the second tool 3 is again aligned with the receptacle/gripper 13 after rotation.

FIGS. 10a, b further show a second axis of rotation of the Z-axis 1 so that the element 1b can be rotated, as particularly indicated by the double arrow in FIG. 10b. Rotating is possible in a continuous manner and at least within an angular range of up to 90°. The range may be larger or smaller. FIG. 10a shows, in particular, that the element 1b may be fork-shaped in order to be able to rotate the machining head 2 within the fork about the second axis of rotation.

In summary, the device according to the invention and the associated method for processing machining patterns (linear and preferably curved machining patterns) have the technical advantage that even for curved/radial/circular machining patterns, e.g., hole circles 6, multi-spindle machining heads may be used, which allows a significant reduction in the machining time/production time. The method may preferably be carried out (almost) fully automatically, including any necessary automatic and rapid change of tools 4, tool spindles 3 and/or machining heads 2.

1-18. (canceled)

19. A CNC machine tool comprising:
a machining head connected to a Z-axis such that it is manually and/or automatically changeable and including at least two tool spindles for receiving tools, said Z-axis being displaceable at least along two linear axial directions, and said Z-axis and/or said machining head having at least one axis of rotation, wherein:
said CNC machine tool is configured such that machining patterns, in particular drilling patterns, are processable in that said machining head is movable to a position of said machining pattern by linearly displacing said Z-axis along at least one of said linear axial directions, and
said tools of said machining head are alignable with a contour of said machining pattern by rotating said machining head and/or said Z-axis.

20. The machine tool of claim 19 wherein said at least two tool spindles are arranged on at least one eccentric connected to said machining head, and a relative position between said tool spindles is adjustable by rotating said eccentric.

21. The machine tool of claim 20 wherein the distance between said tool spindles is adjustable in a manually or numerically controlled automatic manner.

22. The machine tool of claim 19 wherein said at least two tool spindles are arranged in a non-adjustable distance from one another on said machining head.

23. The machine tool of claim 19 wherein at least three tool spindles are arranged in a non-adjustable distance from one another on said machining head, said tool spindles being arranged on a straight line or on a curved line.

24. The machine tool of claim 19 wherein said at least two tool spindles are arranged on at least two linear guides connected to said machining head, and a distance between said tool spindles is adjustable by linearly displacing said tool spindles by means of linear guides.

25. The machine tool of claim 24 wherein the distance between said tool spindles is adjustable in a manually or numerically controlled automatic manner.

26. The machine tool of claim 19 wherein said machining head is manually and/or automatically changeable.

27. The machine tool of claim 19 wherein said machining head is automatically changeable by means of a pick-up method.

28. The machine tool of claim 19 wherein said tools are manually and/or automatically changeable, in particular by means of pick-up methods.

29. The machine tool of claim 19 wherein said machining head has at least a second axis of rotation.

30. The machine tool of claim 19 wherein said machine tool comprises an automatic tool changer which includes at least two receptacles for tools.

31. The machine tool of claim 19 wherein said tool spindles have an internal lubricant feed.

32. A method for multi-spindled production of linear and/or circularly arranged machining patterns, the method comprising:
providing a machine tool comprising:
a machining head connected to a Z-axis such that it is manually and/or automatically changeable and including at least two tool spindles for receiving tools, said Z-axis being displaceable at least along two linear axial directions, and said Z-axis and/or said machining head having at least one axis of rotation, wherein:
said CNC machine tool is configured such that machining patterns, in particular drilling patterns, are processable in that said machining head is movable to a position of said machining pattern by linearly displacing said Z-axis along at least one of said linear axial directions, and
said tools of said machining head are alignable with a contour of said machining pattern by rotating said machining head and/or said Z-axis;
moving to a position on said machining pattern with said machining head by means of a linear displacement of said Z-axis along one or more linear axial directions; and
arranging said tools of said machining head along a contour line of said machining pattern, in particular the outer diameter of the hole circle, by rotating said machining head and/or said Z-axis.

33. The method of claim 32, further comprising adjusting the distance between said tool spindles of said machining pattern prior to processing said machining pattern and/or prior to each drilling operation.

34. The method of claim 32, further comprising displacing said Z-axis and/or said machining head in a linear axial direction which is perpendicular to a plane which is spanned by the other linear axial directions.

35. The method of claim 32, further comprising automatically changing said machining head and/or tool by means of a pick-up method.

36. The method of claim 32, further comprising automatic changing of said tool by means of an automatic tool changer, the automatic changing comprising:
arranging or removing a first tool on/from the associated tool spindle by means of said automatic tool changer;
linearly displacing said Z-axis to a position in which said tool changer can insert or remove a second tool; and
arranging or removing said second tool on/from the associated tool spindle by means of said automatic tool changer.

37. The method of claim 32, further comprising automatic changing of said tool by means of an automatic tool changer, the automatic changing comprising:
arranging or removing a first tool on/from the associated tool spindle by means of said automatic tool changer;
rotating said Z-axis and/or said machining head to a position in which said tool changer can insert or remove a second tool; and
arranging or removing said second tool on/from the associated tool spindle by means of said automatic tool changer.
